(19) United States
(12) Patent Application Publication
(10) Pub. No.: US 2004/0168995 A1
(43) Pub. Date: Sep. 2, 2004

(54) Foil dispensing tray

(76) Inventors: John J. Ignoffo JR., Lakemoor, IL (US); John A. Krueger, Milwaukee, WI (US)

Correspondence Address: John A. Krueger, Sparks International Inc., Suite 270, 16655 West Bluemound Road, Brookfield, WI, 53005, US

(21) Appl. No.: 10/376,446

(22) Filed: Feb. 28, 2003

(51) Int. Cl. B42F 1/00

(52) U.S. Cl. 211/51

(57) ABSTRACT

A dispenser for holding and dispensing individual foil sheets from a stack of foils. Because of the delicate nature of foil, the dispenser has a number of unique requirements to preserve the ability to dispense a single foil sheet. A top plate adds minimal weight to the stack of the foils in order to assist maintaining the stack of foils as one foil is removed. The dispenser protects the edges of the foils to minimize any damage or bending of the edges or corners of the foils to enhance the removal of individual sheets from the stack. A suction cup attached to the bottom of the dispenser minimizes movement of the dispenser with reference to the location of the dispenser. The dispenser has a bottom and end panel bent to angles which promote single dispensing of the top foil sheet. The foil is colored on one side so the cosmetologist may color coordinate different color concentrations to different areas of the customer's hair during a hair highlighting procedure. There are typically two accepted foil sizes to perform hair-highlighting procedures on all lengths of hair. The dispenser is specifically sized for the required foil being dispensed therein. This invention further discloses a double-decked foil dispenser that allows both sizes to be dispensed from the same tray.

### BACKGROUND OF THE INVENTION

1. Field of the Invention

The present invention relates to an improvement in a dispensing tray for supporting foils sheets used within the cosmetic industry for hair highlighting procedures. This includes a configuration of a dispensing tray for supporting the stack of foils to permit dispensing single sheets from a stack of foils without separating the stack from the support. The field of this invention also extends to a dispensing tray improvement for a double-decked design to dispense two sizes of foils used within the cosmetic industry.

2. Background and Description of the Prior Art

The cosmetic industry performs hundreds of thousands of hair highlight procedures each year. The procedure consists of chemically coloring a portion of the customer's hair thereby highlighting specific aspects of the customer's hair. Depending on the customer's desired look, this may be completed by varying the color concentrates applied to specific areas of the customer's hair. For a typical procedure, 50-60 foils may be used. Ultra-thin sheets or foil of thickness less than 0.001″ of aluminum or tin material are typically used for this application. These materials are very inert and do not interact with the chemicals used for the highlighting procedure. The thin nature of the foil is also critical in their functional use during the application and treatment process. The foil is laid under the specific hair segment to be colored or highlighted. The hair is laid onto the foil sheet and brushed with the desired color concentrate. The foil is then folded around the hair bundle several times. About 30-45 minutes later, the foils are removed. Depending on the hair length, various sizes of foil may be used. Colored foils sometimes are used to allow the cosmetologist to visually identify different color concentrates applied to different areas of the customer's hair in order to highlight the hair to the meet the customer's expectations.

Typically, the cosmetologist will use a foil size of about 8″×4″. Off the shelf type foils may be purchased as found in the food service industry. Common in the food serving industry, foil is available in rolls where the outer carton container has a serrated edge for cutting the desired length of foil from the roll. Other companies such as Reynolds recently introduced individual sandwich foil sheets in a box dispenser. The individual foil sheets are interfolded similar to tissue paper. As one foil is pulled from the box, the interfolding technology pulls the edge of the next foil out of the box. The size of these foils is too large for the cosmetologist. Therefore, it is common for the cosmetologist to take all of the foils from the Reynolds foil dispenser and cut the foils in half in order for them to be used for the highlighting procedure. Further cutting of the foil sheets is required for highlighting shorter hair. When the cosmetologist cuts a stack of foils, the edges will not be perfectly matched. They will typically cut the foils with a scissors creating sharp edges on the cut sides. The edges of the bundle being cut will also stick together because of the thin nature of the foil.

There is no specific dispenser for these foils at the desired length. Dispensers for paper and sheets have been around for decades. However, because the nature of foil is so much different than paper, the unique aspects of the foil must be addressed in the design of the dispenser. Foil is much thinner and much more delicate than paper. Foil is made of aluminum, tin or other metals compared with the pulp base of paper products. If a stack of foil has any axial load applied to the corner or edge of the stack of foils, the corner or edge will be damaged. This damage typically would create indentations that cause the foils to stick together making removal of one foil from the stack of foils difficult. Because the foil is so thin, the weight of the foil will also cause the foils to move under the air current typically created by heating and ventilation systems. Notepaper is much more robust and not as affected by force applied to the corners or edges of the paper. The typical notepaper dispensers are flat or provide an acute angle or incline with respect to the surface for which the dispenser is placed upon. This allows the person to write notes on the top sheet of paper in the dispenser prior to removing the sheet from the stack. The incline presents the paper in a better position from which to write upon. As typically found in the industry, one edge of the paper may have an adhesive layer applied to one edge of the stack to allow only a single sheet to be removed from the stack. Other technology introduced by 3M includes an adhesive layer to one side of one end of the paper that sticks to the top of the next paper in the stack. Once removed from the stack, this adhesive layer can allow the notepaper to be applied to another surface. These options are not possible for thin foil technology.

A typical dispenser for notepaper of this type is disclosed in U.S. Pat. No. Des. 273,798 issued May 8, 1984. This dispenser has a surface for supporting the stack of sheet material and relies on the adhesive on the surface of the lower sheet of the stack or on an additional strip of adhesive to secure the stack of sheets or pad to the support surface on the holder. After several uses of the pad holder, it was noted that the surface would become soiled or the strip of adhesive applied to the holder becomes contaminated. This would prevent the pad from being securely mounted to the holder and prevented the separation of one sheet from the stack without the separating force being sufficient enough to also separate the entire stack from the holder. This was particularly noted as the number of sheets in the stack was depleted. Therefore, improvements in holders for dispensing the pressure-sensitive adhesive coated notepapers from a stack became desirable.

Windorski disclosed in U.S. Pat. No. 4,696,399 issued Sep. 29, 1987 an invention that describes an improved notepaper dispenser that afforded a support surface for supporting a stack or pad of sheet material and on a surface that permitted writing on the notepaper before the sheet is rerhoved from the stack. There is no need for enclosures for the stack to protect the sides or edges of the notepaper due to the nature of the paper. Any enclosures would also make writing on the top sheet of the stack difficult. Windbrski, further used the adhesive to prevent each individual paper from being dispensed from the stack. The Windorski dispenser forms an acute angle with the surface that the dispenser is laid on providing an inclined surface for the user to write upon.

### SUMMARY OF THE INVENTION

The present invention relates to an improvement in dispensers for specific use with foil sheets. Because of the characteristics of thin foil sheets, a number of design constraints were required for the dispenser as specified for this invention. This type of product is especially important for the cosmetic industry and more specifically for hair highlight procedures.

The disclosed invention is presented in three variations. The three variations include a large single tray for foils of 4.75″×9″ dimensions, a small single tray for foils of 4.75″×4.75″ dimensions and a double decked tray that includes both the large and small configurations of the foils. Two foil sizes allow the cosmetologist to perform hair highlight procedures on long and short hair customers. Because thin sheet foil is very delicate, the tray for each size of foil provides protection for 500 foils to be placed onto each tray. This will allow the cosmetologist to perform an average of 10 hair highlight procedures with each stack of 500 foils. This could be depleted within 2-3 days for the average cosmetologist. The tray prevents damage to the back and sides of the stack of foil by designing in gap edges to minimize external damage to the edge of the stack. The front edge of the foil is recessed back from the end of the foil to prevent damage to the front edges of the foil stack. The tray provides an obtuse angle with respect to the surface the dispenser is placed upon. This is opposite to the incline of typical paper dispensers. This minimizes the ability for additional foil sheets to inadvertently come out of the dispenser when the top sheet is pulled out. The back panel of the dispenser is slightly inclined forward to promote the top most foil to be pulled from the foil stack. The material of the dispenser can be any acrylic based polymer, Lexan, polycarbonate or the like and may be tinted with many different colors to meet the cosmetologist's aesthetic desires. The thickness of the dispenser is typically between ⅛″- ¼″. This allows sheets of plastic to be cut to the required dimensions. For the bottom panel, the plastic sheet is bent to two different angles to meet the design specifications for foil use while minimizing manufacturing costs.

The cosmetologist has a limited space to work within. Therefore, the dispenser size must be minimized as much as possible. In the event that the dispenser is tipped over, the foils would be damaged making further use cumbersome. The dispenser design has a single suction cup placed at the front of the dispenser to allow the dispenser to be fixed to the cosmetologist's working area and minimize the disruption of the tray. A cut out has been added to the front of the tray to assist in disrupting the vacuum of the suction cup when the dispenser is moved to a different location. Because space is limited, one dispenser may include both the small and large size foil sheets thereby minimizing space.

The foil associated with this invention provides several beneficial features to the cosmetologist. There are two foil sizes corresponding to the two tray designs. It is preferable that one side of the foil is colored or striped a different color than the opposite side that would remain the metallic color of the material. The metallic color of aluminum or tin is silver. The cosmetologist can therefore use the colored side up or silver side up providing visual indication of the color concentrate being applied to the hair of the customer. If the cosmetologist is using two color concentration levels on the customer's hair, the cosmetologist can apply the foils in such a manner to reflect the color concentration by the foil color being used. This would be specifically helpful in coloring different hair strands within the same general area of the customer's hair providing a textured or leveled look. This is especially understood when 50-60 foils are used for the same customer's hair. Foil technology may also have a textured surface applied to one side of the foil. Rolling or pressing the thin foil on a drum during the manufacturing process accomplishes this. The drum would have the desired texture etched or embossed onto its surface. Once the foil has rolled through the drum, one side of the foil would have the imprint of the texture and the opposite side would have the same texture pattern embossed on the surface. The texturing can promote the hair color concentrate to remain evenly dispersed within the foil sheet.

For some manufacturing facilities, the process of cutting the thin sheet foils to a specific length and width requires the application of tissue paper between foils in order for foil edges not to be pressed together. A stack of foils of the desired size for the dispenser may therefore have sheets of tissue paper of the same length and width alternating with the foil sheets. When required by the manufacturing process, the tissue paper also benefits the functioning of the dispenser by providing a non-stick surface for the top foil to be pulled from the stack of foils within the dispenser. A weight plate has been added to the dispenser tray to add weight to the top of the stack thereby promoting a single sheet to be pulled from the top of the dispenser.

### DESCRIPTION OF THE DRAWING

The present invention will be described in greater detail with reference to the accompanying drawing wherein

FIG. 1 is a perspective view of the dual size foil dispenser;

FIG. 2 is a side view of the dual size foil dispenser with the foil sheets positioned within the dispenser;

FIG. 3 is a top view of the weight plate for the small dispenser tray;

FIG. 4 is a top view of the large weight plate for the large dispenser tray;

FIG. 5 is a perspective view of the small foils;

FIG. 6 is a perspective view of the large foils;

FIG. 7 is a perspective view of the small foil size dispenser;

FIG. 8 is a side view of the small foil size dispenser with the foil sheets positioned within the dispenser;

FIG. 9 is a perspective view of the large foil size dispenser;

FIG. 10 is a side view of the large foil size dispenser with the foil sheets positioned within the dispenser.

### DESCRIPTION OF THE PREFERRED EMBODIMENTS

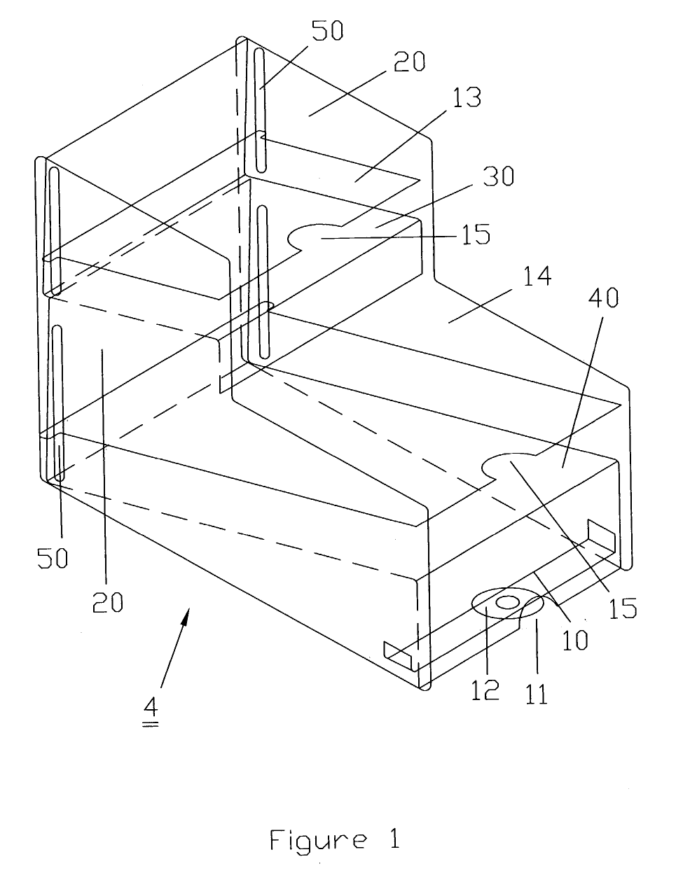

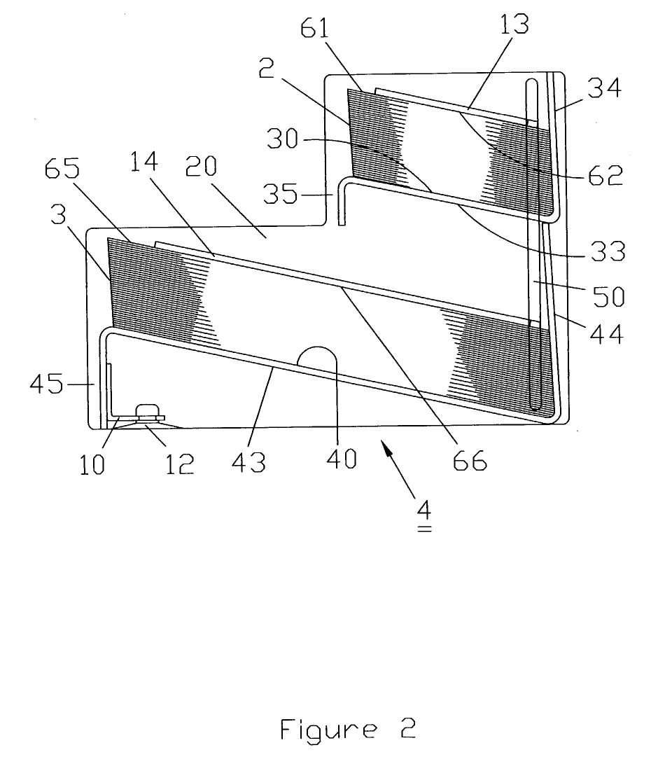

Referring to FIG. 1, double decked tray 4 is shown having one tray for small foils and one tray for large foils. Double-decked tray 4 is shown having two side panels 20 with slots 50 from the top of the side panel to the bottom of the panel. The slots 20 allow the small weight plate 13 and the large weight 14 to slide on top of the foil stack and thereby apply vertical pressure to the foil stack promoting single foil dispensing from the stack of foils. This is further illustrated within FIG. 2. FIG. 2 shows a side view of the double-decked tray 4 with a small stack 2 of foils in the upper tray and a large stack 3 of foils in the lower tray. FIG. 1 and FIG. 2 further illustrates suction cup 12 on support bracket 10 of double-decked tray 4. FIG.1 shows suction cup release notch 11 cut into bottom panel 40 so that the cosmetologist may disrupt the suction when double-decked tray 4 is moved from one location to a different location.

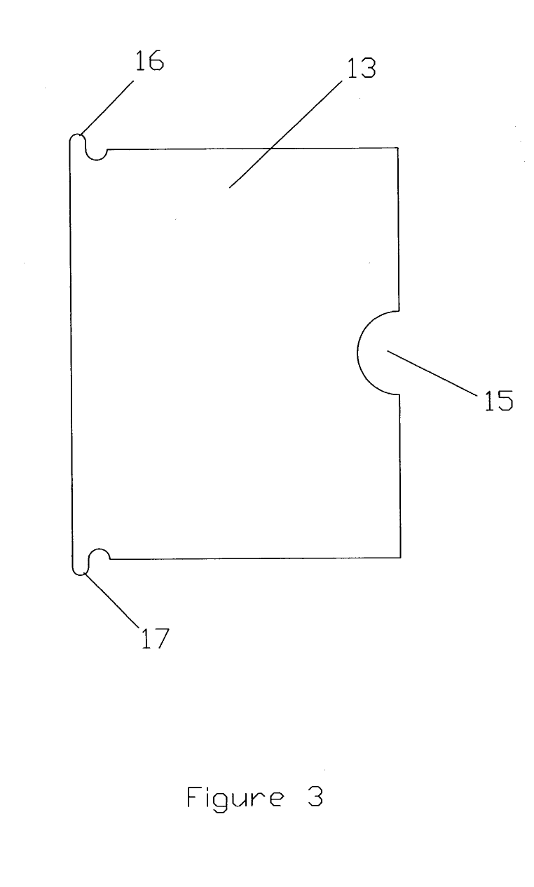

The small foil stack 2 rests within bottom tray portion 30 that has inclined angle 33 away from the tray opening and back angle 34 inclined toward the opening of the tray. The angle between inclined angle 33 and back angle 34 is approximately 75 degrees. Inclined angle 33 presents the small foil stack so that the cosmetologist can grab the top most foil from the stack without disrupting the rest of the foils within the stack. Inclined angle 33 also maintains the foil stack 2 within the tray portion when the top foil sheet is removed from the stack. Back angle 34 promotes the upper most foil to the forward most position with respect to the foil stack 2. Weight plate 13 further promotes single foil dispensing from the small tray by applying vertical weight 62 to the top of foil stack 2. As shown in FIG.1 and FIG. 3, weight plate 13 has finger cut out section 15 for providing the cosmetologist with an area 61 to grab the top most foil from foil stack 2 as shown in FIG. 2. FIG. 2 further illustrates end gap 35, which provides a gap of about ¼ inch in front of foil stack 2 to protect the edge of the foils.

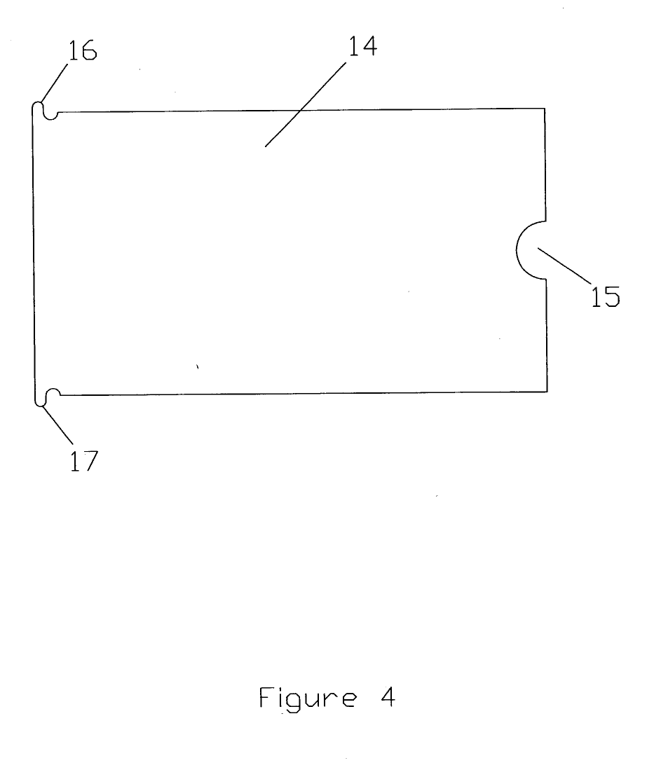

The large foil stack 3 rests within bottom tray portion 40 that has inclined angle 43 away from the tray opening and back angle 44 inclined toward the opening of the tray. The angle between inclined angle 43 and back angle 44 is approximately 75 degrees. Inclined angle 43 presents the large foil stack so that the cosmetologist can grab the top most foil from the stack without disrupting the rest of the foils within the stack. Back angle 44 promotes the upper most foil to the forward most position with respect to the foil stack 3. Weight plate 14 further promotes single foil dispensing from the large tray by applying vertical weight 66 to the top of foil stack 3. As shown in FIG.1 and FIG. 4, weight plate 14 has finger cut out section 15 for providing the cosmetologist with an area 65 to grab the top most foil from foil stack 3 as shown in FIG. 2. FIG. 2 further illustrates end gap 45, which provides a gap of about ¼ inch in front of foil stack 3 to protect the edge of the foils.

FIG. 3 and FIG. 4 shows side extension details 16 and 17 that protrude from the sides of small weight plate 13 and large weight plate 14. Extensions 16 and 17 extend through slots 50 in double decked tray 4 as illustrated in FIG. 1.

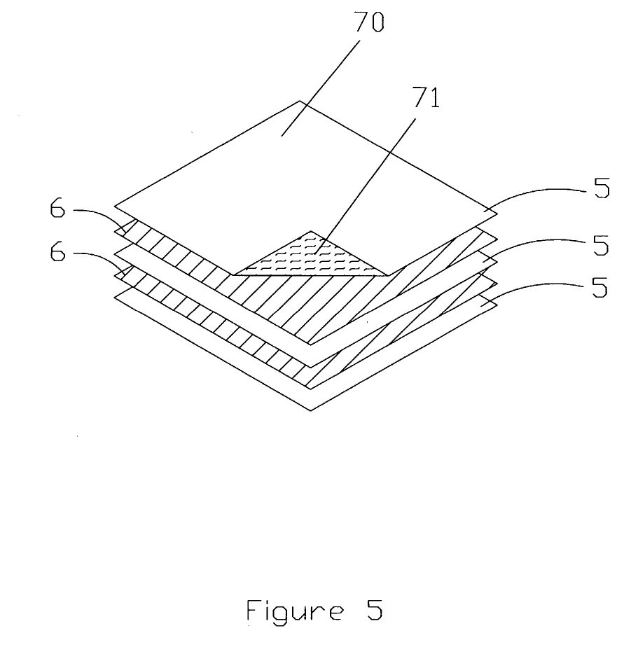

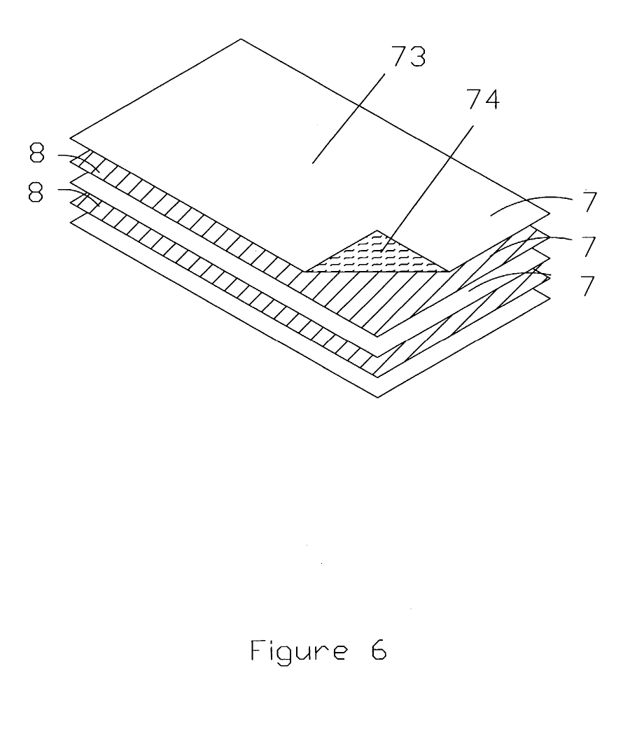

FIG. 5 shows how small foil stack 2 is made up of foils sheets 5 of dimensions of approximately 4.75″ width by 4.75″ long with tissue paper 6 of the same dimensions interspersed between each foil sheet. The tissue paper is required by some manufacturing processes in order to cut stacks of large sheets of foils into the required sizes in the most economical way. The thickness of typical foil is less than 0.001″ and of materials such as aluminum or tin. Foil sheet 5 is further illustrated with the aluminum or tin silver color on the bottom side 71 and colored surface such as gold on the top of foil 70. Having two distinct colors on each foil sheet 5 provides the cosmetologist with visual indications as to color concentrations used on different areas of the customer's hair. FIG. 6 shows how large foil stack 3 is made up of foils sheets 7 of dimensions of approximately 4.75″ width by 9″ long with tissue paper 8 of the same dimensions interspersed between each foil sheet. The cosmetologist will require large foil sheets when the customer's hair is longer than a couple of inches in length. Foil sheet 7 is further illustrated with the aluminum or tin silver color on the bottom side 74 and a color such as gold on the top of foil 73. Having two distinct colors on foil sheet 7 provides the cosmetologist with visual indications as to color concentrations of the colorant used on different areas of the customer's hair.

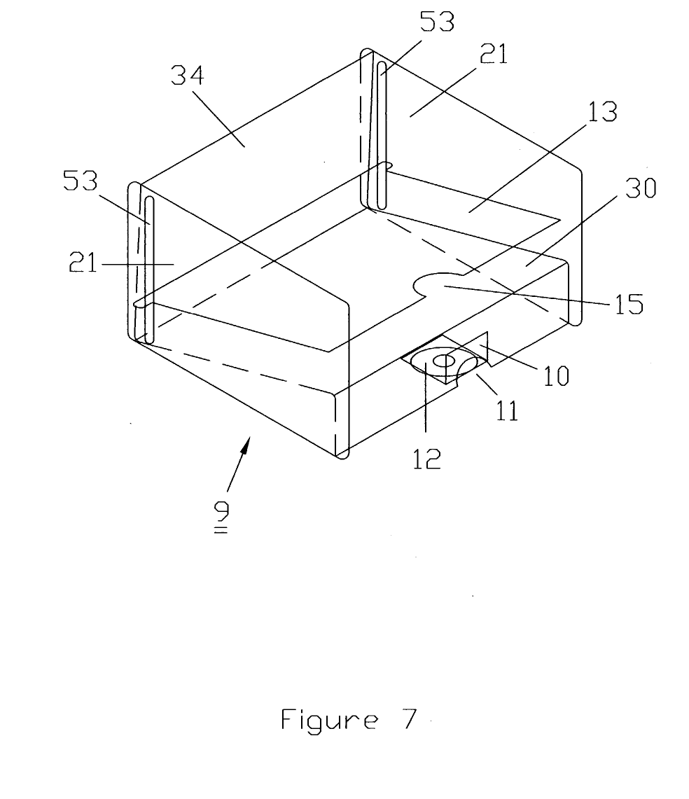

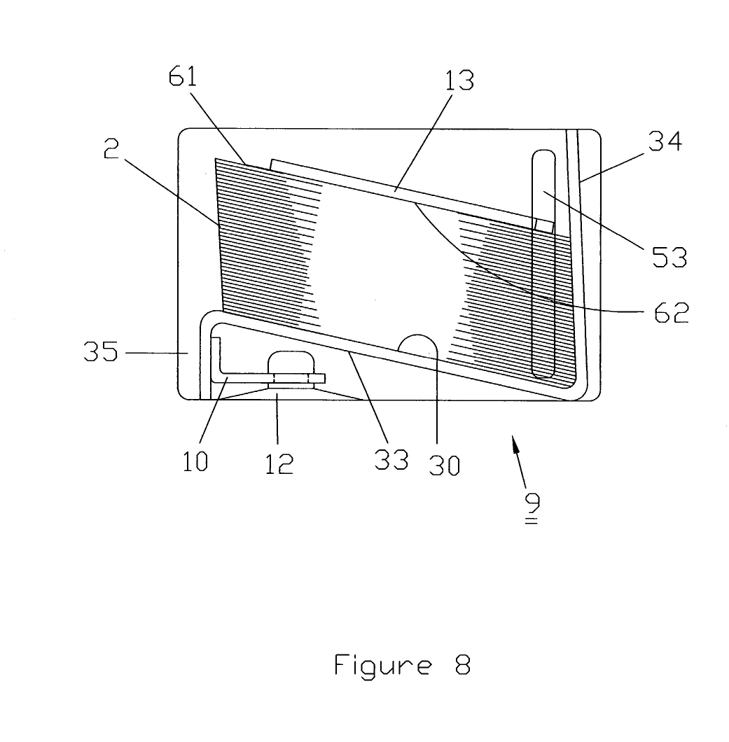

Referring to FIG. 7, a second embodiment of the invention is illustrated for a single foil size dispenser for a small stack of foil 2. Small tray 9 is shown having two side panels 21 with slots 53 from the top of the side panel to the bottom of the panel. The slots 53 allow the small weight plate 13 to slide on top of the foil stack and thereby apply vertical pressure to the foil stack promoting single foil dispensing from the stack of foils. This is further illustrated within FIG. 8. FIG. 8 shows a side view of the small tray 9 with a small stack 2 of foils in the tray. FIG. 7 and FIG. 8 further illustrates suction cup 12 on support bracket 10 of small tray 9. FIG. 7 shows suction cup release notch 11 cut into bottom panel 30 so that the cosmetologist may disrupt the suction when small tray 9 is moved from one location to a different location.

The small foil stack 2 rests within small tray 9 in bottom tray portion 30 that has inclined angle 33 away from the tray opening and back angle 34 inclined toward the opening of the tray. The angle between inclined angle 33 and back angle 34 is approximately 75 degrees. Inclined angle 33 presents the small foil stack so that the cosmetologist can grab the top most foil from the stack without disrupting the rest of the foils within the stack. Back angle 34 promotes the upper most foil to the forward most position with respect to the foil stack 2. Weight plate 13 further promotes single foil dispensing from the small tray by applying vertical weight 62 to the top of foil stack 2. As shown in FIG. 7 and FIG. 8, weight plate 13 has finger cut out section 15 for providing the cosmetologist with an area 61 to grab the top most foil from foil stack 2 as shown in FIG. 8. FIG. 8 further illustrates end gap 35, which provides a gap of about ¼ inch in front of foil stack 2 to protect the edge of the foils.

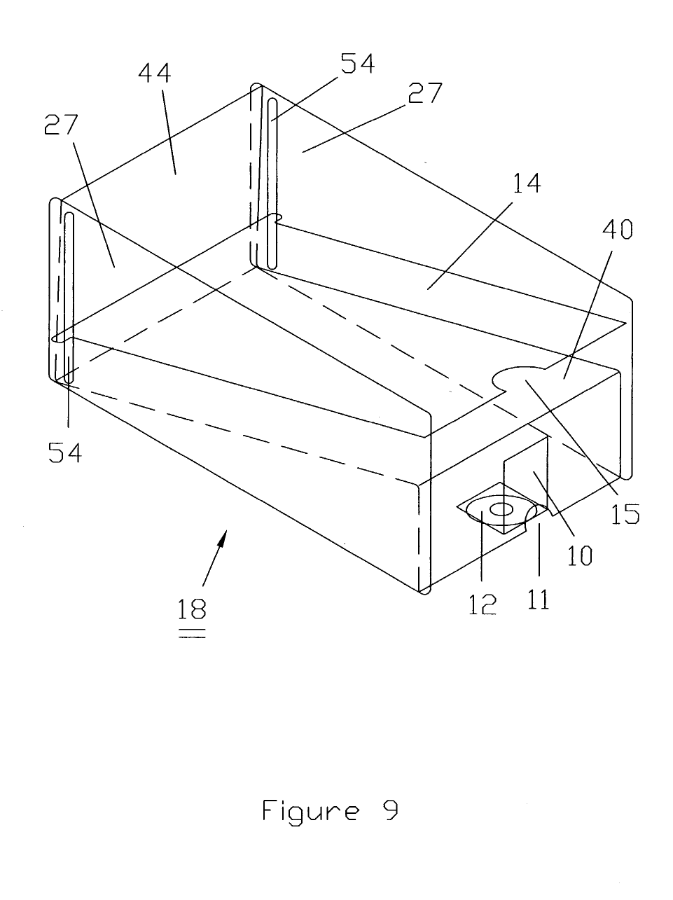

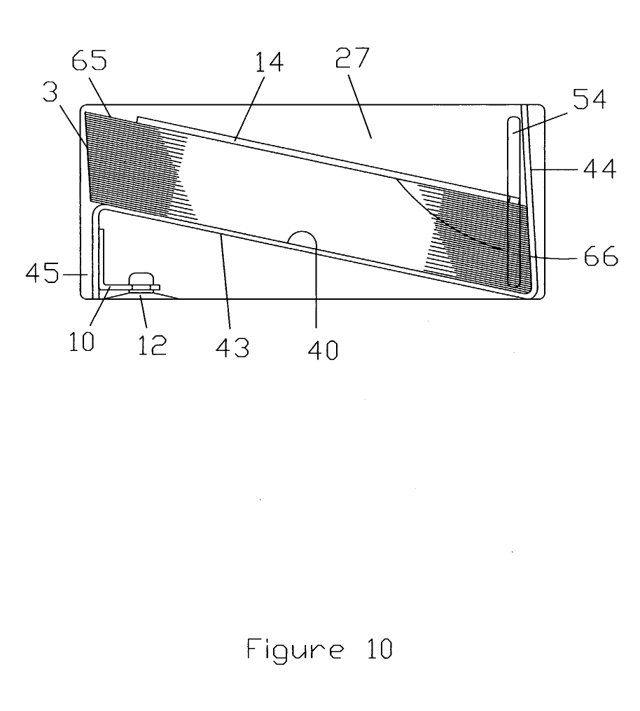

Referring to FIG. 9, another embodiment of the invention is illustrated for a single foil size dispenser for large stack of foil 3. Large tray 18 is shown having two side panels 27 with slots 54 from the top of the side panel to the bottom of the panel. The slots 54 allow the large weight plate 14 to slide on top of the foil stack and thereby apply vertical pressure to the foil stack promoting single foil dispensing from the stack of foils. This is further illustrated within FIG. 10. FIG. 10 shows a side view of the large tray 18 with a large stack 3 of foils in the tray. FIG. 9 and FIG. 10 further illustrate suction cup 12 on support bracket 10 of large tray 18. FIG. 9 shows suction cup release notch 11 cut into bottom panel 40 so that the cosmetologist may disrupt the suction when large tray 18 is moved from one location to a different location.

The large foil stack 3 rests within large tray 18 in bottom tray portion 40 that has inclined angle 43 away from the tray opening and back angle 44 inclined toward the opening of the tray. The angle between inclined angle 43 and back angle 44 is approximately 75 degrees. Inclined angle 43 presents the large foil stack so that the cosmetologist can grab the top most foil from the stack without disrupting the rest of the foils within the stack. Back angle 44 promotes the upper most foil to the forward most position with respect to the foil stack 3. Weight plate 14 further promotes single foil dispensing from the large tray by applying vertical weight 66 to the top of foil stack 3. As shown in FIG. 9 and FIG. 10, weight plate 14 has finger cut out section 15 for providing the cosmetologist with an area 65 to grab the top most foil from foil stack 3 as shown in FIG. 10. FIG. 10 further illustrates end gap 45, which provides a gap of about ¼ inch in front of foil stack 3 to protect the edge of the foils.

Having thus defined the present invention with reference to a preferred embodiment and several other embodiments, it is to be understood that other embodiments may be formed which do not depart from the spirit of the invention or the scope of the invention as claimed in the appended claims.

I claim:

1. A dispenser comprising:
two side walls, a back panel and a support member having a generally planar support surface for supporting the stack of sheet material away from the front opening of the dispenser;

2. Said dispenser of claim 1 where back panel is inclined toward the front opening of the dispenser;

3. Said dispenser of claim 2 where length and wide of dispenser provides minimal gaps for the stack material to be placed within the dispenser;

4. Said dispenser of claim 3 where bottom panel is longer than sheet material so that the stack of sheet material is recessed from the front opening of the dispenser;

5. Said dispenser of claim 4 where bottom panel has a support bracket and suction cup to apply a removable vacuum adhesion of the dispenser to the surface it is applied to;

6. Said dispenser of claim 5 where the bottom panel has a cut out region for breaking the vacuum lock;

7. Said dispenser of claim 5 where two bottom panels are included within the sidewalls providing dispensing of two stack material sizes;

8. Said dispenser of claim 7 where the sidewalls include slots for weight panel extensions. Weight panel rests upon top of stack of material.

9. A dispensing system comprising:
two side walls, a back panel and a support member having a generally planar support surface for supporting the stack of sheet material away from the front opening of the dispenser; and a stack of material;

10. Said dispensing system of claim 9 where back panel is inclined toward the front opening of the dispenser;

11. Said dispensing system of claim 10 where length and width of dispenser provides minimal gaps for the stack material placed within the dispenser;

12. Said dispensing system of claim 11 where bottom panel of dispenser is longer than sheet material so that the stack of sheet material is recessed from the front opening of the dispenser;

13. Said dispensing system of claim 12 where bottom panel has a support bracket and suction cup to apply a removable vacuum adhesion of the dispenser to the surface it is applied to;

14. Said dispensing system of claim 13 where the bottom panel of dispenser has a cut out region for breaking the vacuum lock;

15. Said dispensing system of claim 13 where two bottom panels are included within the sidewalls providing dispensing of two stack material sizes;

16. Said dispensing system of claim 15 where the sidewalls include slots for weight panel extensions. Weight panels rest upon the top of the stack of material;

17. Said dispensing system of claim 9 where stack of material includes foil;

18. Said dispensing system of claim 17 where foil is colored on one side;

19. Said dispensing system of claim 18 where foil is textured on one side.
